(19) United States
(12) Patent Application Publication
(10) Pub. No.: US 2002/0188732 A1
(43) Pub. Date: Dec. 12, 2002

(54) System and method for allocating bandwidth across a network

(76) Inventors: Charles R. Buckman, Austin, TX (US); Dennis J. Cox, Austin, TX (US); Donovan M. Kolbly, Austin, TX (US); Craig Cantrell, Austin, TX (US); Brian C. Smith, Fort Worth, TX (US); Jon H. Werner, Austin, TX (US); Marc Willebeek-LeMair, Austin, TX (US); Joe Wayne Blackard, Austin, TX (US); Francis S. Webster III, Austin, TX (US)

Correspondence Address: Robert W. Holland, Baker Botts LLP, Suite 600, 2001 Ross Avenue, Dallas, TX, 75201-2980, US

(21) Appl. No.: 09/875,639

(22) Filed: Jun. 6, 2001

(51) Int. Cl. G06F 15/16

(52) U.S. Cl. 709/228

(57) ABSTRACT

A system and method for allocating bandwidth across a network to and from different end point nodes improves the predictability and efficiency of best effort network architectures. Advanced traffic processors associated with end point nodes detect and classify packets transferred across a network and allocate bandwidth. A packet policy module of the advanced traffic processor allocates bandwidth by applying policy definitions, flow ID rules, and flow policy maps to prioritize packet flows. In one embodiment, bandwidth is allocated on demand on a per-download basis so that bulk file transfers are provided substantially reduced download times through allocation of bandwidth for a premium fee.

### TECHNICAL FIELD OF THE INVENTION

This invention relates generally to computer networks, and more specifically relates to a system and method for allocating bandwidth within a network.

### BACKGROUND OF THE INVENTION

The success of the Internet has arisen largely from its use of a simple and unified protocol to exchange data. Computer systems and networks interfaced with the Internet are thus able to exchange data that in turn enables more complex applications built on top of the Internet protocol. The Internet's relatively simple underlying protocol and ability to support more complex applications has lead to an explosion of Internet usage by homes and businesses for a large variety of applications, such as banking, brokerage services, marketing, sales and news publications. As demand for Internet-based services through these applications has increased, demand for capacity to transfer data across the Internet has also increased.

Initially, Internet service was provided to homes and businesses largely through dial-up connections established with analog modems over the “Plain Old Telephone System” (POTS) by Internet service providers (ISPs). ISP subscribers call into an ISP modem bank to establish an Internet interface with the ISP's intranet. ISP intranets are typically private networks that use a backhaul network, such as DS-3 or OC-12, that connects multiple “last mile” networks to a regional data center (RDC). The RDC typically hosts multiple centralized servers, such as CDN caching servers and mail servers, and provides connections to Tier 1 networks, either through peering points to access the Internet or gateways to special purpose networks such as the public service telephone network (PSTN). ISP intranets typically include multiple RDCs interfaced with high speed interconnects, such as OC-12 to OC-192.

Although the Internet's relatively simple underlying protocol allows the interfacing of individual users and different intranets, one significant difficulty with the Internet is that data transfers typically are made on a “best effort” basis. In the Internet's best effort architecture, TCP\IP packets are generally transferred between routing points without prioritization, leading to unpredictable data transfer rates and the Internet's nickname of the “world wide wait”. Conventional dial-up modems typically have presented the most significant bottleneck to data transfer due to their relatively low data transfer rates of 56K or less. However, bottlenecks also occur along the Internet infrastructure when surges in activity result in delays as data transfer rates exceed infrastructure capacity at various points, including ISP intranet infrastructure.

More recently, slower analog dial-up modems are being replaced with higher capacity broadband modems, such as DSL and cable modems. The high capacity of these broadband modems has increased the usefulness of the Internet for services with large data transfers, such as video, gaming, peer-to-peer applications and downloading large software files. Although these larger-capacity broadband modems have reduced bottlenecks at user end points, the introduction of significantly greater user end point capacity has exasperated delays along other points of the networks as end users take advantage of broadband services requiring large data transfers. Thus, although broadband modems are able to support relatively large data transfer rates, actual data transfers typically still occur on a best efforts basis resulting in data transfer rates at less than the capacity of the broadband modems. Thus, even though broadband cable and DSL modems provide greater end user capacity, the modems rarely maintain data transfers at their full capacity and end-users are still subject to delays in data transfer caused by bottlenecks in the infrastructure of the ISP's Intranet as well as the Internet.

One solution to allocating bandwidth for ISP Intranets is to simply build more infrastructure to carry data. For instance, an Intranet infrastructure with capacity equal to the sum of its end point users would not theoretically experience delays in data transfer. However, infrastructure is expensive and the business of providing Internet access is essentially a commodity business with low margins. In addition, excess capacity often goes unused since end point users do not typically interface with the Internet simultaneously. Moreover, although building additional ISP infrastructure improves data transfer rates within the ISP Intranet, it does not necessarily improve the efficiency of the Intranet's data transfer with Tier 1 networks that may still experience delays during surges of activity. Thus, even if an end point user's Internet interface through an ISP Intranet occurs at the highest capacity available to the end point user's modem, data transfer rates are typically still unpredictable since the originating server transferring the data to the end point user may be slowed by congestion either at the originating server or in the Internet infrastructure.

### SUMMARY OF THE INVENTION

Therefore a need has arisen for a system and method which allocates bandwidth across an Internet network.

A further need has arisen for a system and method which assigns bandwidth capacity to network end points based on priority classifications for packets communicated with the end point.

In accordance with the present invention, a system and method is provided that substantially eliminates or reduces disadvantages and problems associated with previously developed systems and methods for assigning bandwidth across an Internet network. Advanced traffic processors associated with network end point nodes detect packets transferred across the nodes and select priority parameters that allocate bandwidth to the transmission of the packets across the network.

More specifically, packets flowing through a network ingress end point are automatically classified, such as according to the application, origin, destination, user, time of day or other information associated with each packet. Based on classification information, an appropriate networking protocol and priority parameter are selected from a predetermined list of protocols and parameters and allocated to a predetermined bandwidth priority, thus effectively coupling classification information with allocation of bandwidth. An advanced traffic processor associated with the ingress end point applies the assigned protocol and priority parameter of the packet to prioritize the transmission of the packet, for instance by assigning the packet to one of plural priority queues or by tagging the packet with priority identifiers.

The advanced traffic processor interfaces data through a programmable network processor that inspects, routes and modifies packet flows with little latency or delay. Packets flow through an upstream port interface and are inspected by a packet classification module that detects whether the packet belongs to a priority application. A packet policy module selects priority parameters based on the classification of the packets and policy definitions, flow identification rules, and flow policy maps. Based on the priority parameter, a packet processing module prioritizes the transmission of the application packet, either through specific handling or identification added to the packets. The processed application packets are then continued in the data flow through the downstream port of the network processor.

A host processor associated with the advanced traffic processor supports programmability of the policy definitions, flow identification rules and flow policy maps applied by the packet policy module. The host processor also supports communication with a management server and a service provider network management system to track data flows. The management server maintains information for configuring policies, such as the priority parameters applicable to particular applications.

The present invention provides a number of important technical advantages. One important technical advantage is that bandwidth within a network is allocated according to applications, origin, destination, user, time of day, etc . . . by associating application packets with priority parameters. In this manner bandwidth allocation in a network for predetermined services may be enhanced or reduced to improve the overall predictability of data flows through the network. Thus, for instance, bandwidth hogs such as large file downloads are identified and their impact is limited on other network traffic. Indeed, unauthorized network transfers may be completely stopped.

Another important technical advantage of the present invention is that bandwidth may be allocated more efficiently by associating a cost structure with predetermined applications. For instance, a priority parameter may provide different levels of bandwidth allocation dependent upon the origination or destination of a packet. In one embodiment, multiple tiers of service are available to end point users with premium service providing greater bandwidth allocation for a greater cost. In another embodiment, packet flows from the Internet to an end point user are enhanced when an Internet site pays a premium to have a greater bandwidth allocation for downloads to end users.

Another important technical advantage of the present invention is that the improved predictability of data flows and reduction of bottlenecks in an ISP Intranet improves reliability for services that require low latency. For instance, voice over IP (VOIP) generally requires a predictable allocation of bandwidth to obtain toll quality. Even over networks having large bandwidth capacity, voice over IP tends to have reduced quality as packets carrying voice data are transmitted over the networks at varying rates. The present invention provides improved voice over IP by allocating predetermined bandwidth resulting in improved predictability.

### BRIEF DESCRIPTION OF THE DRAWINGS

A more complete understanding of the present invention and advantages thereof may be acquired by referring to the following description taken in conjunction with the accompanying drawings in which like reference numbers indicate like features and wherein:

FIG. 1 depicts a block diagram of a network for allocating bandwidth;

FIG. 2 depicts a block diagram of an advanced traffic processor;

FIG. 3 depicts a block diagram of a network that allocates bandwidth through tunnels;

FIG. 4 depicts a block diagram for content delivery from the Internet through an Intranet tunnel; and

FIG. 5 depicts a block diagram for packet classification and routing through tunnels.

### DETAILED DESCRIPTION OF THE INVENTION

Preferred embodiments of the present invention are illustrated in the figures, like numerals being used to refer to like and corresponding parts of the various drawings.

Internet data transfers across networks typically use TCP\IP packets transferred with a best effort approach. The best effort approach tends to perform unpredictably at higher capacity data transfer rates since packets are transferred as capacity permits, resulting in unforeseeable delays as surges in data traffic occur. For instance, a single user can cause bottlenecks by placing large demands on capacity with large data transfers, even if the transfers occur over a relatively short time period. To provide improved predictability of data transfer rates in the best efforts architecture of the Internet, the present invention couples applications to an allocation of bandwidth. Packets are classified by application and assigned an appropriate priority protocol and parameters so that packets associated with predetermined applications are handled with a predetermined priority through the network. In essence, classification and routing by applications operates as a bandwidth switch for a best efforts network.

Referring now to FIG. 1, a block diagram depicts an ISP intranet 10 that provides Internet access from plural end point users 12 to a variety of end point Tier 1 networks, including the Internet 14, the public switch telephone network (PSTN) 16, and a game network 18. End point users 12 include residences and businesses that interface with modem plants 20. The interface between end points 12 and modem plant 20 is typically referred to as the “last mile”, and includes cable connections that use broadband cable modems and DSL connections that provide broadband interfaces over otherwise analog twisted pair telephone lines. Modem plants 20 typically terminate at an aggregation router which routes data to the ISP intranet 10. Intranet 10 typically has several geographically distributed regional data centers (RDC) 22 that each typically have large capacity routers interfaced through a backhaul network capable of transferring generally large capacities of data.

On each edge of ISP intranet 10, an advanced traffic processor (ATP) 24 intercedes between the intranet 10 and the respective end point so that data packets ingressing into intranet 10 pass through an ATP and egress through an ATP. ATPs 24 allocate bandwidth to applications by creating priority tunnels across intranet 10, thus ensuring that data packets for predetermined applications have predetermined bandwidth available to them. Priority tunnels establish connections between devices and have well defined priorities to ensure appropriate levels of quality of service for predetermined applications. ATPs 24 inspect and route packets onto appropriate priority tunnels and perform network overhead functions such as traffic policing, collecting metering information for billing, and admission control to ensure that priority tunnels are not overloaded.

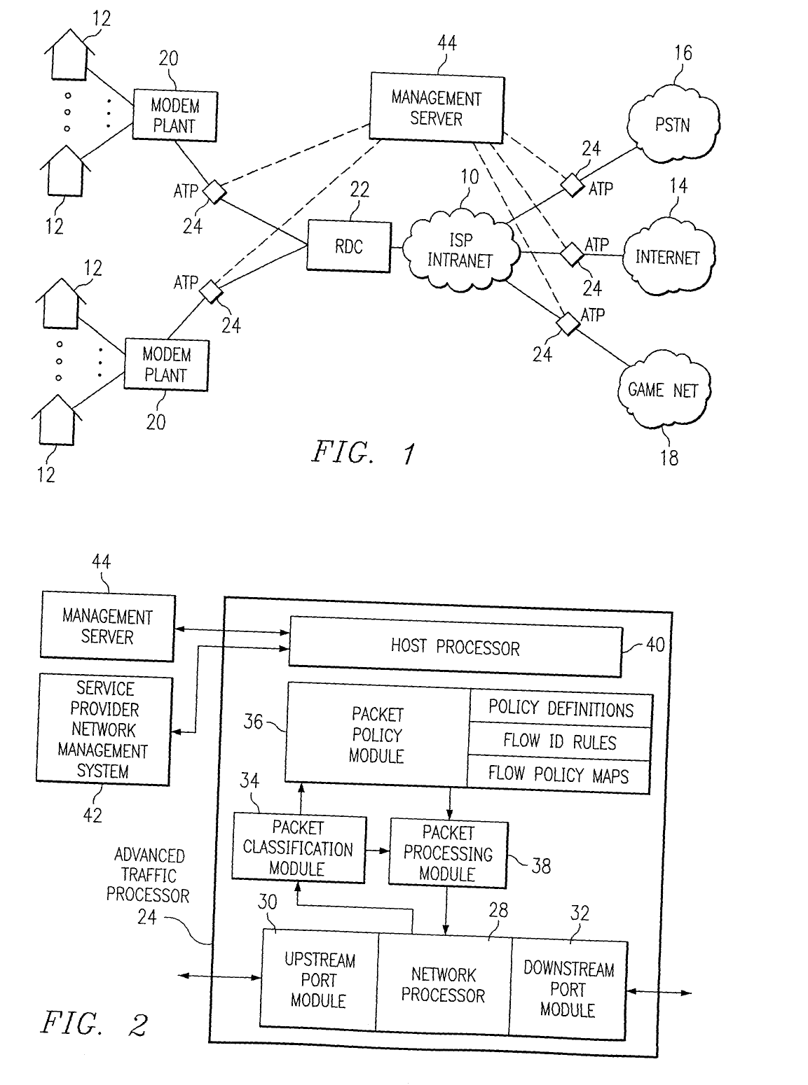

To perform these functions each ATP acts as a bandwidth switch that determines bandwidth allocations and routes packets appropriately. Referring now to FIG. 2, a block diagram depicts components of an ATP 24 that perform the bandwidth switching functions. ATP 24 has a network processor 28 with an upstream port module 30 interfaced with end points of intranet 10 and a downstream port module 32 interfaced with intranet 10. Network processor 28 is a new generation general purpose chip that replaces standard router chips but performs the two basic functions common to router fast path, packet classification and routing. The fast path functions in network processors, such as are available from Agere, are controlled by software that allows a programmer to classify a packet on virtually any field of the packet, including the Mac address (layer 2), the source or destination IP address (layer 3), the port number (layer 4), or even the contents of the packet such as a URL (layer 5 and higher). Software controls give network processors increased flexibility to inspect, route and modify packet flows at high network speeds with virtually no latency. Each ATP 24 includes plural network processors and replaceable port modules that allow interfacing with data connections to support speeds ranging from fractional DS-3 to OC-192.

Network processor 28 analyzes packet data traffic to identify packet data flows and match the packet data flows to applications, users or devices. Once analyzed and identified, the packet data flows may be counted, modified, delayed, dropped or encapsulated and then sent to a user or destination end point. A packet classification module 34 associated with network processor 28 directs inspection and classification of packets to classify packets according to the application associated with the packet. Based on these classifications, a packet policy module 36 determines an appropriate priority for the packet and a packet processing module 38 ensures proper handling of the packet by the network.

Packet policy module 36 selects priority parameters for packet applications based on configurations that define policy definitions, flow identification rules, and flow policy maps. Policy definitions define the traffic shaping, metering, and tagging/encapsulation functions for packets classified according to applications. Flow identification rules include software for network processor 28 and parameters that allow network processor 28 to match packets to flows. Flow policy maps define policies for packet data traffic flows once those flows are identified. A packet processing module 38 prioritizes packet data flows based on the packet classification and the appropriate policy for that application so that bandwidth is effectively allocated for the network according to the applications based on the policies. Packet processing module 38 prioritizes packets in a number of different manners, including queuing packets until bandwidth is available, thus effectively reducing bandwidth for low priority flows, tagging packets with priority identifiers to simplify and speed processing through the network, and even deleting packets that are associated with unauthorized applications. Further, bandwidth may be dynamically allocated by altering definitions rules and maps to adapt to network use and thus more efficiently use available bandwidth. For instance, if an ATP 24 establishes a VOIP interface with an end user, the management server may increase the allocation of bandwidth upon detection of the VOIP interface to establish a VOIP tunnel between the end user and the POTS network for the duration of the call. When the call is over, dynamic allocation of bandwidth to other tunnels from the VOIP tunnel improves allocation of bandwidth for other uses.

ATP 24 includes a host processor 40 interfaced with a service provider network management system 42 and a management server 44. Management server 44 monitors one or more advanced traffic processors for performance and failure, configures policies for bandwidth allocation, maps users and applications to policies, and collects metering data for billing. Management server 44 maintains and updates the policy definitions, flow identification rules and flow policy maps used by advanced traffic processors 26. These definitions, rules and maps control the establishment of tunnels for applications, thus improving data transfer predictability by allocating network bandwidth as tunnels dedicated to applications.

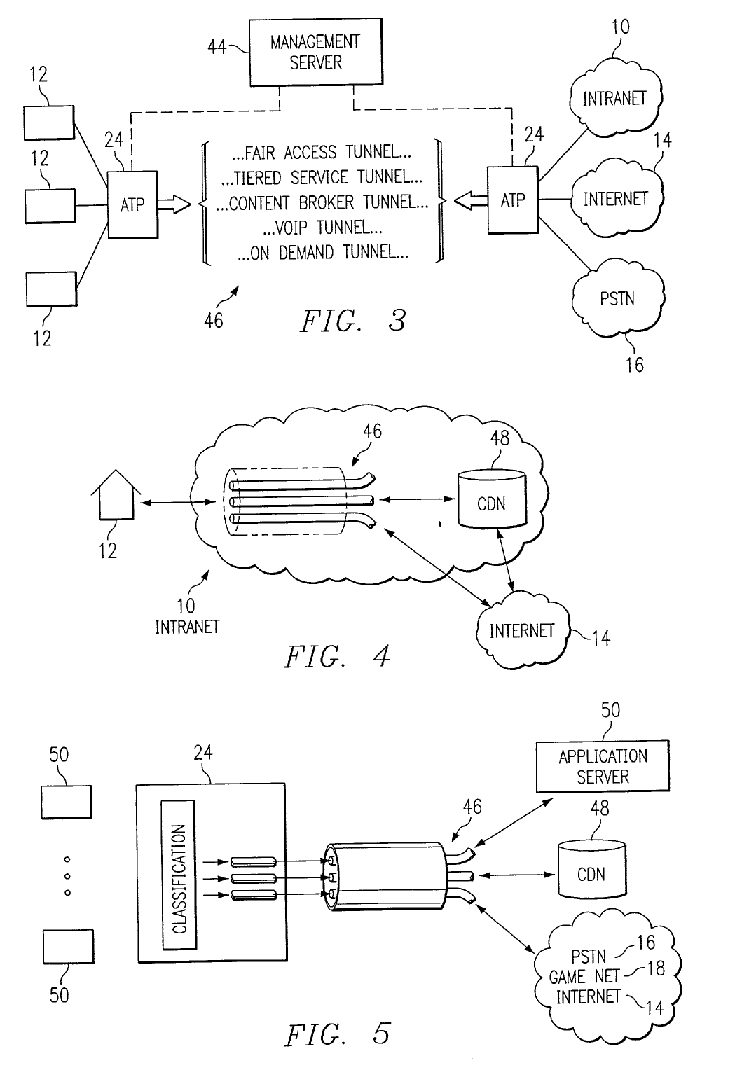

Referring now to FIG. 3, a blocked diagram depicts plural end point user nodes 12 that, in a “best efforts” network, are essentially in competition for bandwidth to transfer data with destination end point nodes, such as nodes within intranet 10, nodes associated with other Internet 14 sites and the (PSTN) 16. Bandwidth is allocated for the transfer of data by advanced traffic processors 24 through the establishment of a series of tunnels 46 that are associated with applications, such as predetermined functions, end point users, and/or end point destinations. The tunnels 46 allocate bandwidth to improve predictability of data transfers over the network and allow an ISP to efficiently allocate bandwidth and service levels across an ISP's intranet in relationship to the cost and value of each application for subscribers and/or content providers for subscribers.

One embodiment of a tunnel 46 is a fair access tunnel that dynamically and fairly allocates available bandwidth in the last mile of an ISP intranet that is associated with plural end point user nodes 12. In typical best effort broadband networks, the modems associated with “last mile” end point nodes have a considerably greater total capacity to handle data transfers than the associated modem plant 20, so that a single end point user can cause bottlenecks with extended downloads of large data files. A fair access policy monitors data transfers to and from end point nodes to limit the impact of excessive bandwidth use by a particular end point user, such as by slowing data transfer to and from such users. Thus, each end point node 12 is guaranteed that a predetermined allocation of bandwidth will be available because ATP 24 prevents any one of the end point nodes from consuming an unfair amount of bandwidth over a predetermined time period.

An end point user 12 who maintains long-lived TCP connections for bulk file transfers, such as FTP transfers, can also have a negative impact on bandwidth availability throughout an ISP intranet. Packet classification module 34 of the ATP 24 that is associated with end point nodes 12 identifies bulk file transfer packets and applies flow policy maps that reduce the data transfer rates of such packet flows. For instance, packet processing module 38 directs network processor 28 to store bulk file transfer packets in queue and release those packets at a rate that consumes only a predetermined bandwidth allocation. In this way, an allocation of bandwidth to a user prevents that user from overloading other network nodes. A fair access tunnel may be established between two (ATPs) 24 or by a single ATP that reduces the rate at which bulk file transfer packets are accepted into intranet 10. Further, ATP 24 may allocate different levels of bandwidth to different types of bulk file transfer packets. For instance, an intranet 10 can allocate a predetermined bandwidth for FTP downloads with the bandwidth shared by all users while limiting or eliminating peer-to-peer downloads, such as Napster music files, during peak network usage times. Thus, peer-to-peer applications that initiate data transfers even when users are not involved at the end point node 12 will not take valuable bandwidth from applications that do involve an ISP subscriber.

A tiered services tunnel allows a broadband ISP to allocate different amounts of bandwidth to different users based on different subscription costs. An end point user 12 subscription level is loaded on an ATP 24 associated with the end point user 12's IP address. If an end point user subscribes for a lower speed service, ATP 24 classifies packets originating from or destined to that end point user's IP address according to the service level. If the end point user's data transfer rate exceeds the associated subscription level data transfer rate, ATP 24 queues data associated with that IP address so that only a predetermined allocation of bandwidth is consumed by that end point user.

A content broker tunnel allows for allocation of bandwidth to content providers who send content data packets through intranet 10 to an end user 12. For instance, an e-commerce site that desires high customer satisfaction may pay a premium to have its content data packets given priority through intranet 10 to end users 12. In this way, end users who access the e-commerce content provider's data receives more rapid downloads, improving the likelihood of the end user's selection of that e-commerce provider over other e-commerce sites that are less responsive. An ATP 24 that receives content data packets from a preferred Internet content provider classifies the content data packets as having a higher priority and allocates them for transfer through an appropriate content broker tunnel. Management server 44 tracks content packets that receive priority, allowing an ISP to charge a premium for the allocation of bandwidth through the content broker tunnel.

A Voice Over IP tunnel allows transfer of voice data from an end point user 12 to PSTN 16 that meets toll quality standards for latency, loss and jitter characteristics. When ATP 24 detects a Voice Over IP packet transferred from or to an end point user 12, it first verifies that the end point user is authorized for Voice Over IP service, and then meters the Voice Over IP packets for billing and routes the Voice Over IP packets through a Voice Over IP tunnel. The Voice Over IP tunnel carries the Voice over IP packets to an ATP 24 associated with a gateway server to the PSTN 16. The Voice Over IP tunnel ensures toll quality voice traffic flow through the allocation of adequate bandwidth and by giving the Voice Over IP packets high priority through intranet 10.

An on-demand tunnel allocates bandwidth for an application on a per-application basis that allows users or content providers to ensure a rapid transfer of a predetermined file in a desired time period. For instance, an end point user 12 who desires to purchase a large software file or multimedia file, such as a DVD movie, from an Internet content provider may purchase a bandwidth allocation to obtain an expedited download. Ordinary download times for large files may take hours even over broadband end point modems and are unpredictable due to variations in data traffic across intranet 10. To shorten the download time, the user selects a premium download service in which extra bandwidth is allocated to the bulk download from the Internet content provider. When the Internet content provider initiates the bulk download to the end point user, the bulk content packets include classification information to indicate that premium bandwidth allocation was purchased by the downloading end user. An ATP 24 receives the inbound bulk packet flow and allocates the bulk packet flow to an on-demand tunnel to ensure rapid download of the bulk file transfer to the end user. The on-demand tunnel allocates bandwidth through intranet 10 so that up to the bandwidth capacity of the end user node 12 is made available for the bulk file transfer, resulting in transfer times that are maximized for each end user. Management server 44 tracks the premium bulk transfers and bills the content provider as appropriate who can in turn pass the premium cost on to the subscriber.

Management server 44 allocates bandwidth to help ensure efficient data transfer over intranet 10. For instance, during periods of low network activity, management server 44 allocates greater amounts of bandwidth for fair access tunnel and tiered service tunnels to improve service without degradation of other services. Management server 44 then reduces allocation to fair access and tiered service tunnels during times of higher network usage and when services such as on-demand tunnel requests are made that result in less bandwidth availability.

Referring now to FIG. 4, a block diagram depicts one embodiment of the present invention in which a content delivery network is defined and created through an Intranet 10 with one or more ATPs 24. An end user 12 requests a predetermined content from Internet 14. Once the request is received at the Internet destination, the destination forwards the request to a content delivery network server 48 associated with Intranet 10 that has the requested content stored in an associated database. Content delivery server 48 provides the requested content to end user 12 through an appropriate tunnel 46 by identifying the content as an application for classification by an associated ATP 24. For instance, ATP 24 classifies the content by an associated IP address, port number, user identification, destination company site, URL or type of underlying application. Packets associated with the content may also be tagged or encapsulated with standard mechanisms such as MPLS, VLAN, and Diffserv. Content delivery server 48 provides improved content delivery whether requested by a user, such as with an increased bandwidth to download a file, or by a content provider, such as an internet service seeking improved timeliness for its site. Further, based on content classification, ATPs 24 can re-direct content to route the content through a desired path or to a desired destination.

Referring now to FIG. 5, a block diagram depicts the flow of packets 50 through an ATP 24 for routing through tunnels 46. ATP 24 classifies packets 50 and assigns the packets to appropriate queues for rate control and priority. The rate control and priorities established by ATP 24 ensures that bandwidth allocations are enforced for tunnels 46. For example, packets classified to be associated with application server 50, such as packets associated with specific applications of Oracle, Outlook, or SAP, are transferred through an associated tunnel 46. Similarly, packets associated with a content delivery application, such as bandwidth provided on demand for a file download to a user, are classified and assigned to appropriate queues for an associated tunnel 46. The rate control provided by queuing is transparent to users and allows bandwidth allocation that improves the efficiency of best efforts networks by reducing congestion associated with bottlenecks, such as acknowledgments and re-transmission associated with lost packets.

Although the present invention has been described in detail, it should be understood that various changes, substitutions and alterations can be made hereto without departing from the spirit and scope of the invention as defined by the appending claims.

What is claimed is:

1. A system for allocating bandwidth of an Internet Service Provider intranet network that provides Internet access to plural subscribers, the intranet network having plural end point nodes, the system comprising:
an advanced traffic processor associated with each end point node of the intranet network;
a network processor associated with each advanced traffic processor, the network processor operable to determine classification information for packets transferred across the network; and
a packet processing module associated with the network processor, the packet processing module operable to prioritize the transfer of packets across the network so that one or more tunnels having predetermined bandwidth of the network are allocated to one or more classification informations.

2. The system of claim 1 wherein the classification information identifies packets associated with a subscriber and wherein the packet processing module prioritizes the subscriber packets based on a predetermined allocation of bandwidth purchased by the subscriber.

3. The system of claim 2 wherein the allocation of bandwidth purchased by the subscriber comprises one of plural levels of bandwidth allocation.

4. The system of claim 3 wherein the packets exceed the subscriber's allocation of bandwidth, the packet processing module operable to delay transfer of the excess packets.

5. The system of claim 1 wherein the classification information identifies packets associated with a subscriber download from an internet content provider wherein the packet processing module prioritizes the content provider packets based on a predetermined allocation of bandwidth purchased by the content provider.

6. The system of claim 1 wherein the classification information identifies packets associated with a subscriber download of a bulk file from the Internet and wherein the packet processing module prioritizes the bulk files based on a predetermined allocation of bandwidth for the bulk file.

7. The system of claim 1 wherein the classification information identifies packets associated with Voice Over IP and wherein the packet processing module prioritizes the Voice Over IP packets based on a predetermined allocation of bandwidth associated with a desired latency.

8. The system of claim 1 further comprising a packet classification module associated with the network processor, the packet classification module operable to determine classification information for one or more packets according to the application associated with each packet.

9. A method for allocating bandwidth of an Internet service provider intranet network, the method comprising:
determining classification information associated with packets ingressing the intranet;
processing the packets according to their associated classification information; and
transferring the packets through tunnels established in the intranet, each tunnel having a predetermined bandwidth allocation and each the packet associated with a tunnel.

10. The method of claim 9 wherein:
determining classification information further comprises classifying packets in one of plural service levels based on the identity of the intranet subscriber associated with the packets; and
transferring the packets further comprises transferring packets associated with an intranet subscriber through one of plural tunnels, each tunnel having a bandwidth allocation associated with providing a predetermined service level.

11. The method of claim 10 further comprising:
adjusting the bandwidth allocation of the plural tunnels to maintain at least a predetermined service level as data transfer rates fluctuate across the network.

12. The method of claim 9 wherein:
determining classification information further comprises classifying predetermined types of packets as associated with bulk file transfers and the identity of an intranet subscriber; and
transferring the packets further comprises transferring the bulk file transfer packets at or below a predetermined data transfer rate having a bandwidth allocation associated with providing a predetermined service level to the subscriber.

13. The method of claim 9 wherein:
determining classification information further comprises classifying predetermined packets as associated with a bulk file transfer; and
transferring the packets further comprises transferring the bulk file transfer packets through a tunnel having a bandwidth allocation to provide expedited download of the bulk file transfer.

14. The method of claim 9 wherein:
determining classification information further comprises classifying predetermined packets as associated with a Voice Over Internet packet flow; and
transferring the packets further comprises transferring the Voice Over Internet packets through a tunnel having a bandwidth allocation to provide predetermined latency.

15. The method of claim 9 wherein:
determining classification information further comprises classifying predetermined packets as associated with an internet content provider; and
transferring the packets further comprises transferring the content provider packets through a tunnel having a bandwidth allocation to provide expedited download of content from the content provider to end user nodes of the intranet.

16. A method for transferring data over a best effort network having plural end points, the method comprising:
associating data packets ingressing each end point with classification information that associates the packet with one of plural applications;
allocating predetermined bandwidth of the best effort network to each of the one or more applications; and
transferring the data packets through the bandwidth allocation of the application associated with the data packets.

17. The method of claim 16 wherein associating data packets with one or more applications comprises associating data packets with the IP address of an end node of the network.

18. The method of claim 16 wherein associating data packets with one or more applications comprises associating data packets with the IP address of a content provider interfaced with the network.

19. The method of claim 16 wherein associating data packets with one or more applications comprises associating data packets with a bulk file transfer to an end node of the network.

20. The method of claim 16 wherein one of the applications comprises Voice Over Internet.

21. A system for expedited transfer of a bulk file from a content provider to an end user node through an Internet Service provider intranet, the system comprising:
a first advanced traffic processor associated with the intranet and interfaced with the end user node;
a second advanced traffic processor associated with the intranet and interfaced with the content provider; and
a tunnel established through the intranet between the first and second advanced traffic processors, the tunnel having a predetermined bandwidth;
wherein the first and second advanced traffic processors identify packets associated with the bulk file and route the bulk file packets through the tunnel.

22. The system of claim 21 further comprising a graphical user interface associated with the end user node, the graphical user interface operable to request expedited download of the bulk file from the content server.

23. The system of claim 21 wherein the predetermined bandwidth of the tunnel is substantially equal to the bandwidth capacity of the end user node.

24. The system of claim 21 wherein the content provider provides classification information with the bulk file and wherein the advanced traffic processors identify packets based on the classification information.

25. The system of claim 21 wherein the second advanced traffic processor identifies bulk transfer packets based on the origination IP address of the packets and classifies the bulk transfer packets for routing through the tunnel.

26. A method for expedited transfer of bulk files through an Internet service provider intranet, the method comprising:
selecting an expedited download of a bulk file from a content provider to an end user node of the intranet;
identifying packets of the bulk download with classification information; and
routing packets having the bulk download classification information through a tunnel of the intranet, the tunnel having a predetermined bandwidth allocation for accomplishing the expedited transfer of the bulk file.

27. The method of claim 26 wherein the predetermined bandwidth allocation is substantially equal to the bandwidth available to the modem of the end user node.
